(19) United States
(12) Patent Application Publication
(10) Pub. No.: US 2008/0168049 A1
(43) Pub. Date: Jul. 10, 2008

(54) Automatic acquisition of a parallel corpus from a network

(75) Inventors: Jianfeng Gao, Kirkland, WA (US); Ying Zhang, Melbourne (AU); Ke Wu, Shanghai (CN)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/650,660

(22) Filed: Jan. 8, 2007

(51) Int. Cl. G06F 17/30

(52) U.S. Cl. 707/5; 707/3; 707/E17.107

(57) ABSTRACT

Network pages are identified based on whether the pages include image alternative text that indicates that the network pages contain links to pages that are translations of each other. A plurality of pages and a plurality of respective uniform resource locators are downloaded from a server associated with the domain name of the identified network pages. The uniform resource locators are used to identify a set of candidate parallel page pairs and a set of features are created for each candidate parallel page pair. The sets of features are used to identify parallel page pairs, wherein the pages in a parallel page pair are translations of each other.

### BACKGROUND

A parallel corpus is a collection of documents where the content of the documents is provided in multiple separate languages. Examples of such parallel corpora include European Parliament Proceedings, which are written in eleven European languages, and biblical text, which has been written in a number of languages. Parallel corpora are valuable resources for training machine translation systems, cross-language information retrieval systems and other data driven natural language processing systems.

Documents that can be used to form parallel corpora can also be found in multi-lingual websites on the Internet. Such sites typically provide the same content in different languages on different parallel pages of the site. Thus, one page may provide the content in English while another page provides the same content in Chinese. For bilingual websites, the two parallel pages are referred to as a parallel pair.

Given the size of the Internet, an automatic system is needed to identify websites that may contain parallel pages and to identify the specific pages that form parallel pairs.

The discussion above is merely provided for general background information and is not intended to be used as an aid in determining the scope of the claimed subject matter.

### SUMMARY

Network pages are identified based on whether the pages include anchor text and/or image alternative text that indicate that the network pages contain links to pages that are translations of each other. A plurality of pages and a plurality of respective uniform resource locators are downloaded from a server associated with the domain name of the identified network pages. The uniform resource locators are used to identify a set of candidate parallel page pairs and a set of features are created for each candidate parallel page pair. The sets of features are used to identify parallel page pairs, wherein the pages in a parallel page pair are translations of each other.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a flow diagram of a method for identifying parallel pairs from a network under one embodiment.

FIG. 2 is a block diagram of elements used to identify parallel pairs from a network under one embodiment.

FIG. 3 is a list of text elements that can be used to search for candidate network sites under an embodiment.

FIG. 4 is a flow diagram for identifying candidate pairs based on URLs for candidate pages.

FIG. 5 is a block diagram of an example computing environment in which embodiment may be practiced.

### DETAILED DESCRIPTION

Embodiments described herein identify pages on a network that are translations of each other. These pages are referred to as parallel pairs. The embodiments involve identifying candidate sites that may contain parallel pairs, identifying candidate parallel pairs, and verifying that the candidate parallel pairs are translations of each other.

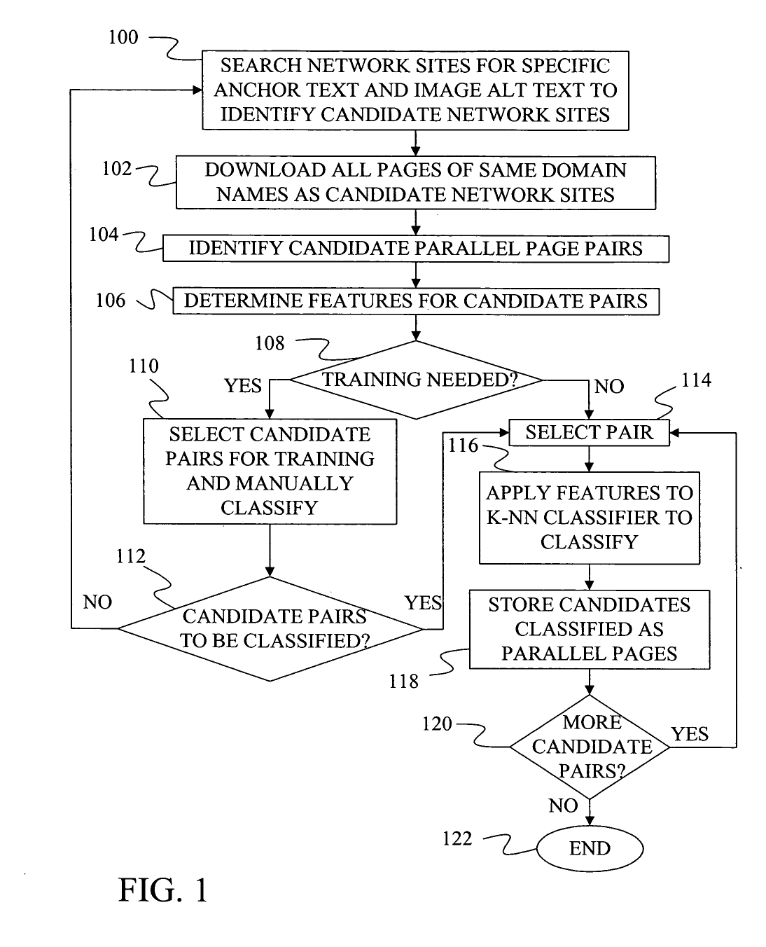

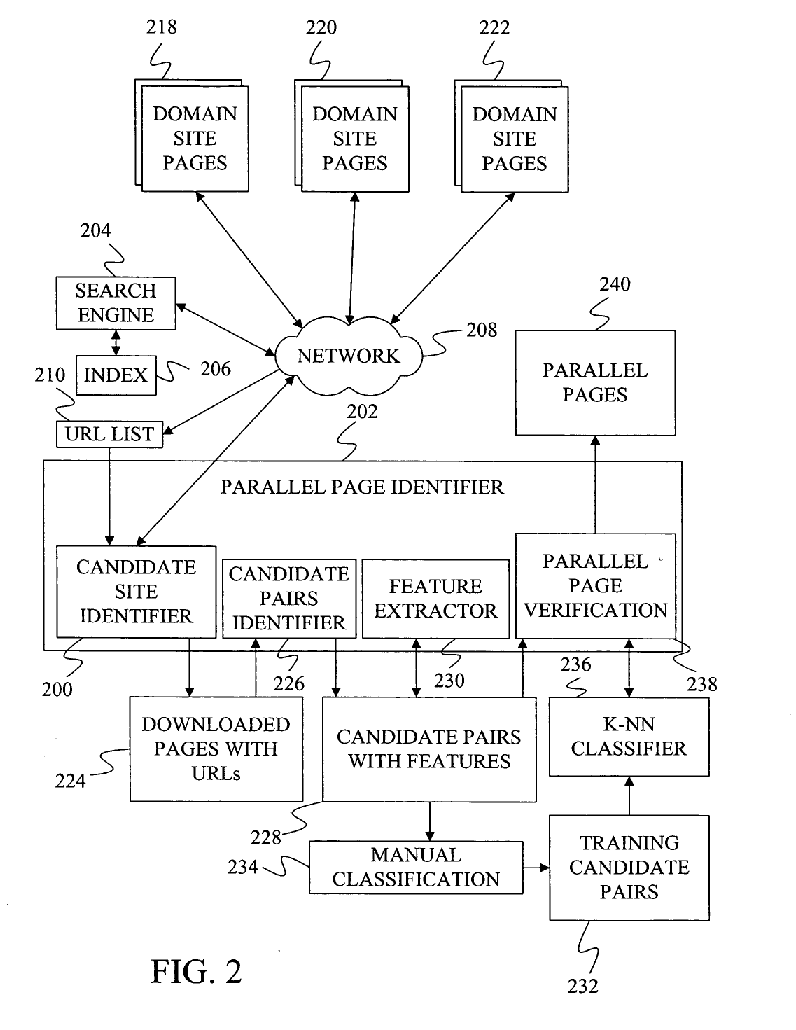

FIG. 1 provides a flow diagram for identifying parallel pairs under one embodiment. FIG. 2 provides a block diagram of elements used in the method of FIG. 1.

In step 100, a candidate site identifier 200 of a parallel page identifier 202 searches for websites with specific text to identify candidate network sites that may contain parallel pages. Under one embodiment, candidate site identifier 200 submits a search to a search engine 204 that includes an index 206. Based on the search criteria in the search request, search engine 204 examines index 206 to identify web pages, such as pages in domain site pages 218, 220 and 22, that include the text provided by candidate site identifier 200. Search engine 204 then returns the uniform resource locator (URL) for each of the web pages that it finds.

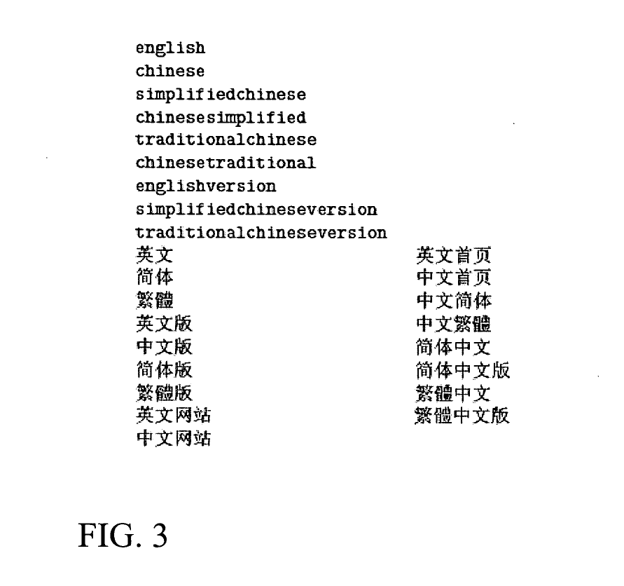

Under one embodiment, the text that candidate site identifier 200 searches for includes a list of predefined strings that include some type of reference to a language. FIG. 3 provides an example list of predefined search strings that candidate site identifier 200 could use for an embodiment that searches for English and Chinese parallel pages. As can be seen from FIG. 3, the list includes terms like “English,” “Chinese,” and “simplifiedChinese.” The list also includes the Chinese equivalents of these terms.

Under some embodiments, to avoid identifying incorrect web pages, the search is limited to anchor text and image alternative text. Anchor text is text found between an open anchor tag, <a>, and close anchor tag, </a>, in a Hyper-Text Markup Language (HTML) document. Such anchor tags are used to identify links to network pages. Within the open anchor tag, the link to another network page is defined by setting an “href” attribute equal to the uniform resource locator (URL) of the linked network page. The text or image to be displayed on the current page to represent the link is placed between the open anchor tag and close anchor tag. For example: <a href=“http://www.xxxx.com/aa/bb/eng/cc/content_e.html”> English Version </a>

In this anchor tag structure, “English Version” would be displayed on the current page and when a user clicked on this phrase, the network browser would request and display the web page at the URL: http://www.xxxx.com/aa/bb/eng/cc/conetent_e.html.

In HTML it is also possible to include an image between the open anchor tag and the close anchor tag to allow an image to represent the link such that if the user clicks on the image, the web page defined by the URL in the open anchor tag will be requested. To identify the image, an image tag, <img>, is inserted between the open and close anchor tags. Within the image tag, a source attribute, “src”, provides the network path to the file that contains the image, and an alternative text attribute, “alt”, provides text that is to be displayed on the page if the image can not be located or can not be rendered. For example:

<a href=“http://www.xxxx.com/aa/bb/eng/cc/content_e.html”>
<img src=“button.gif” alt=“English version”>
</a>

Thus, under some embodiments, both the anchor text and the image alternative text is searched to determine if it contains the list of predefined strings that are associated with candidate pairs such as the strings found in FIG. 3. This can be done by including references to the anchor tags and the “alt” attribute in the search query. By using the image alternative text in addition to the anchor text, these embodiments significantly increase the number of network pages that can be located to contain parallel pages.

Based on the search of anchor text and image alternative text, search engine 204 returns a list 210 of uniform resource locators for network pages that include the search strings, such as those in FIG. 3, as either anchor text or image alternative text.

At step 102, candidate site identifier 200 uses URL list 210 to download all of the pages associated with the domain name of each URL in URL list 210. The domain name is the portion of the URL after the prefix http:// and before the next forward slash “/”. For example, in the URL examples above, the domain name is www.xxxx.com. Typically, the network pages for a domain name are stored on one or more servers for the domain. To download the pages for a domain name, any of a large number of known tools such as “wget”, which is available at http://www.gnu.org/software/wget may be used. These tools request the pages from the domains such as domain site pages 218, 220 and 222. These downloaded pages are then stored as local downloaded pages 224 that have a directory hierarchy based on the hierarchies in the domains. In addition to downloading the pages, the URL for each page is also downloaded and stored.

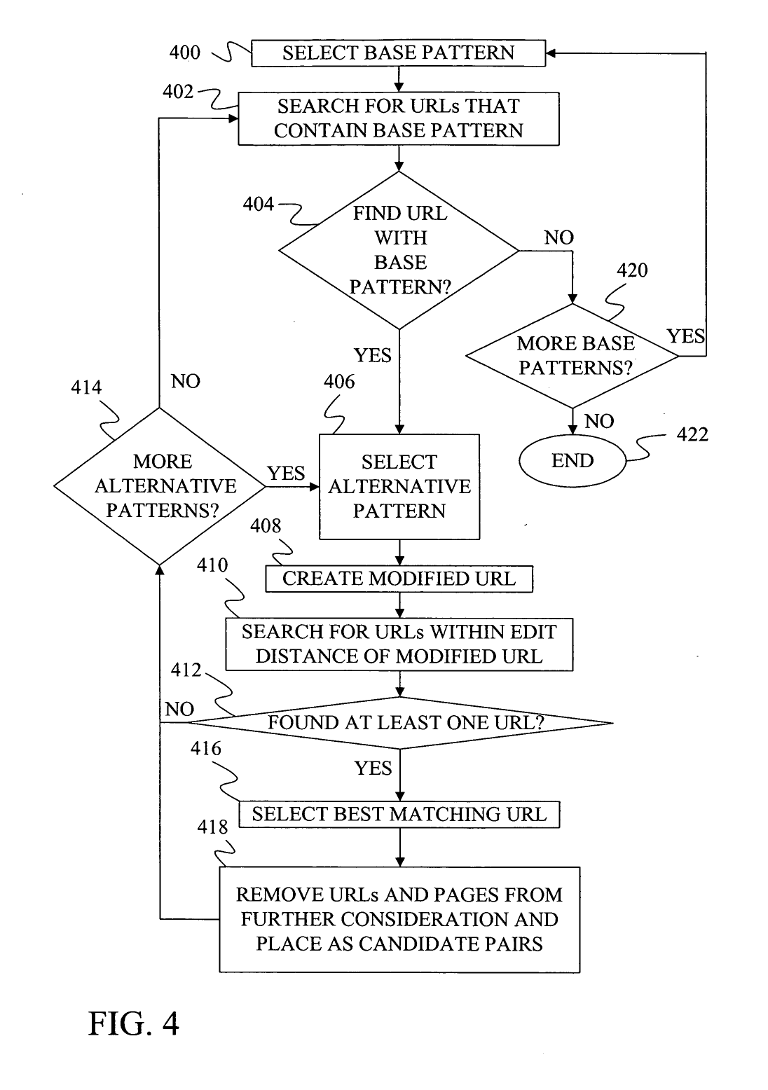

At step 104, a candidate pairs identifier 226 in parallel page identifier 202 uses the URLs of the downloaded pages 224 to identify candidate pairs 228, which represent pages that may be translations of each other. FIG. 4 provides a more detailed flow diagram of a method of identifying candidate pairs in step 104.

In the method of FIG. 4, candidate pairs are identified by determining if the URLs for two pages contain certain text sequences, referred to as patterns, that indicate that the two pages are translations of each other. For example, if the URL contains one of a set of patterns such as “e”, “en”, “eng”, “engl”, or “English”, it can indicate that the URL is for an English version of a web page. In one embodiment, the patterns for one language, such as English, are more limited than the patterns for another language, such as Chinese. In the method of FIG. 4, the more limited pattern set is referred to as a base pattern set and each pattern within this set is referred to as a base pattern. The pattern set for the other language is referred to as an alternative pattern set.

At step 400, a base pattern is selected. For example, under one embodiment, the base patterns consists of “e”, “en”, “eng”, “engl” and “English.” At step 402, the URLs in downloaded pages 224 are searched to identify URLs that contain the base pattern. At step 404, if a URL is found that contains the base pattern, an alternative pattern is selected at step 406. An alternative pattern is a character or sequence of characters that indicates a document in another language. For example, in an embodiment for Chinese, the alternative pattern list would include “c”, “ch”, “chi” and “Chinese.”

After selecting one of the alternative patterns from the alternative pattern list, the URL that contains the base pattern is modified at step 408 to form a modified URL by replacing the base pattern with the selected alternative pattern. At step 410, the URLs associated with the same domain name as the URL that contained the base pattern at step 402 are searched to determine if any of the URLs are within an edit distance threshold of the modified URL. The edit distance may be calculated in any of a number of known manners including adding one to the edit distance for each insertion, deletion, or movement of a character that is needed to transform the URL under consideration into the modified URL. Under many embodiments, the edit distance threshold is greater than one such that a candidate pair may be identified even though there are differences between the modified URL and one of the downloaded URLs.

At step 412, the process determines if at least one URL is within the edit distance threshold of the modified URL. If none of the URLs are within the edit distance threshold of the modified URL, the process continues at step 414 where a determination is made as to whether there are additional alternative patterns that need to be considered. If there are more alternative patterns, the process continues at step 406 by selecting the next alternative pattern and steps 408, 410 and 412 are repeated for the new alternative pattern. If there are no more alternative patterns, the process returns to step 402 to continue to search for URLs that contain the base pattern.

If there is at least one URL that is within the edit distance threshold of the modified URL at step 412, the best matching URL is selected at step 416. Under one embodiment, the best matching URL is the URL with the smallest edit distance. At step 418, the best matching URL determined at step 416, and the URL with the base pattern are removed from further consideration and their pages are placed as candidate pairs in candidate pairs 228. The process then returns to step 414 to determine if there are additional alternative patterns that should be searched.

The search for URLs that contain the base pattern continues until no URLs are found at step 404. The process then determines if there are more base patterns in the base patterns list at step 420. If there are more base patterns, the next base pattern is selected by returning to step 400 and the steps described above are performed for the newly selected base pattern. When there are no more base patterns in the base pattern list at step 420, the process of FIG. 4 ends at step 422.

After the candidate pairs have been identified at step 104 of FIG. 1, a feature extractor 230 determines features for each candidate pair at step 106. These features will later be used to classify the candidate pair as representing parallel pages or as not representing parallel pages. Under one embodiment, three features are extracted from candidate pairs 228.

The first feature is a file length ratio, which is the number of bytes in one page of the candidate pair divided by the number of bytes in the other page of the candidate pair. A second feature is the difference between the HTML structures of the two pages in the candidate pair. To determine the difference in the HTML structures, a linear sequence of HTML tags is extracted from each page of the candidate pair and the case of the tags is normalized to either all uppercase or all lowercase. In addition, attributes such as “meta”, “font” and “scripts” are removed from the tags. The linear sequences of HTML tags are then compared to one another to identify tags that are found in one but not the other page. An example of such a tool is sdif, which is available at http://linexcommand.org/man_pages/sdif1.html. For example, if two pages have the following linear sequences of HTML tags:

| Page A | Page B |
|---|---|
| <HTML> | <HTML> |
| <HEAD> | <HEAD> |
| <TITLE> | <TITLE> |
| </TITLE> | </TITLE> |
| </HEAD> | </HEAD> |
| <BODY> | <BODY> |
| <TABLE> | </HEAD> |
| <TR> | <BODY> |
| <TD> | <TABLE> |
| <TABLE> | <TR> |

Then sdif would produce the following results:

| Lines | Page A | # Not Aligned | Page B |
|---|---|---|---|
| 1 | <HTML> | | <HTML> |
| 2 | <HEAD> | | <HEAD> |
| 3 | <TITLE> | | <TITLE> |
| 4 | </TITLE> | | </TITLE> |
| 5 | </HEAD> | | </HEAD> |
| 6 | <BODY> | | <BODY> |
| 7 | | 1> | </HEAD> |
| 8 | | 2> | <BODY> |
| 9 | <TABLE> | | <TABLE> |
| 10 | <TR> | | <TR> |
| 11 | <TD> | 3< | |
| 12 | <TABLE> | 4< | |

Under one embodiment, the difference score is determined as the ratio of the number of unaligned lines divided by the total number of aligned lines and the total number of unaligned lines. For example, in the example above, the number of unaligned lines is four and the total number of aligned and unaligned lines is twelve resulting in a structural difference score of 4/12=⅓. In general, lower difference scores are associated with more similar pages.

The third feature extracted from the two pages is a measure of the similarity of the non-HTML content on the page. To determine this similarity, the HTML tags are removed from the pages and the remaining text is applied to a translation alignment tool that aligns sentences in the two pages based on a bilingual dictionary and/or a statistical translation model. Under one embodiment, the Champollion Tool Kit, which is available at http://champollion.sourceforge.net/, is used to perform the alignment. The score for the content similarity is then determined as the ratio of the number of aligned sentences over the number of aligned and unaligned sentences.

Once the features for the candidate pairs have been determine, the process of FIG. 1 continues at step 108 where it is determined if training of a k-nearest neighbor classifier is needed. If the k-nearest neighbor classifier has not been trained, manual classification 234 is applied to at least some of candidate pairs 228 at step 110 to form training candidate pairs 232. Such manual classification can be performed by having experts in the two languages determine which candidate pairs provide translations of each other and which candidate pairs do not. Thus, the candidate pairs are manually classified into either being parallel pages or not being parallel pages. The resulting training candidate pairs 232 include both manual classification and feature vectors that represent the pairs.

At step 112, the process determines if there are candidate pairs to be classified. If there are no candidate pairs to be classified, all of the candidate pairs that were identified in step 104 were used to form the training candidate pairs. As such, the process returns to step 100 to locate new candidate pairs that can be classified.

If candidate pairs are available to be classified at step 112 or if training was not needed at step 108, a candidate pair from candidate pairs 228 is selected for classification by parallel page verification unit 238 at step 114. At step 116, the features for the selected candidate pair are applied to a k-nearest neighbor classifier 236. K-nearest neighbor classifier 236 uses training candidate pairs with manual classification 232 to identify the training candidate pairs that have the closest feature vectors to the feature vector of the selected candidate pair. Each feature vector consists of the values of the features determined in step 106. The distance between feature vectors can be determined either as a Euclidean distance or as an angular distance. The k training candidate pairs that have the nearest feature vectors to the feature vector of the selected candidate pair are identified by k-nearest neighbor classifier 236.

The classifications of the k-nearest neighbor training candidate pairs are then examined to determine which classification is most common among the k-nearest neighbors. For example, if a majority of the k-nearest neighbor training candidate pairs was classified as containing parallel pages, k-nearest neighbor classifier 236 would classify the selected candidate pair as containing parallel pages. If a majority of the k-nearest neighbor training candidate pairs were classified as not containing parallel pages, the selected candidate pair would be classified by as not containing parallel pages.

Under one embodiment, a tenfold cross-validation experiment was conducted to identify the optimal value for k. Under some embodiments, k=15 was set for three-dimensional feature vectors and k=7 was set for two-dimensional feature vectors.

If k-nearest neighbor classifier 236 classifies a candidate pair as a parallel page, parallel page verification unit 238 stores the candidate pair as parallel pages 240 at step 118.

At step 120, the process of FIG. 1 determines if there are more candidate pairs 228. If there are more candidate pairs, the process returns to step 114 to select the next candidate pair from candidate pairs 228. When there are no further candidate pairs, the process ends at step 122 and parallel pages 240 contains the parallel pages mined from the network that represent translations of each other. Parallel pages 240 may then be used for any number of purposes including training statistical translation systems, translation disambiguation systems, and out of vocabulary term translation.

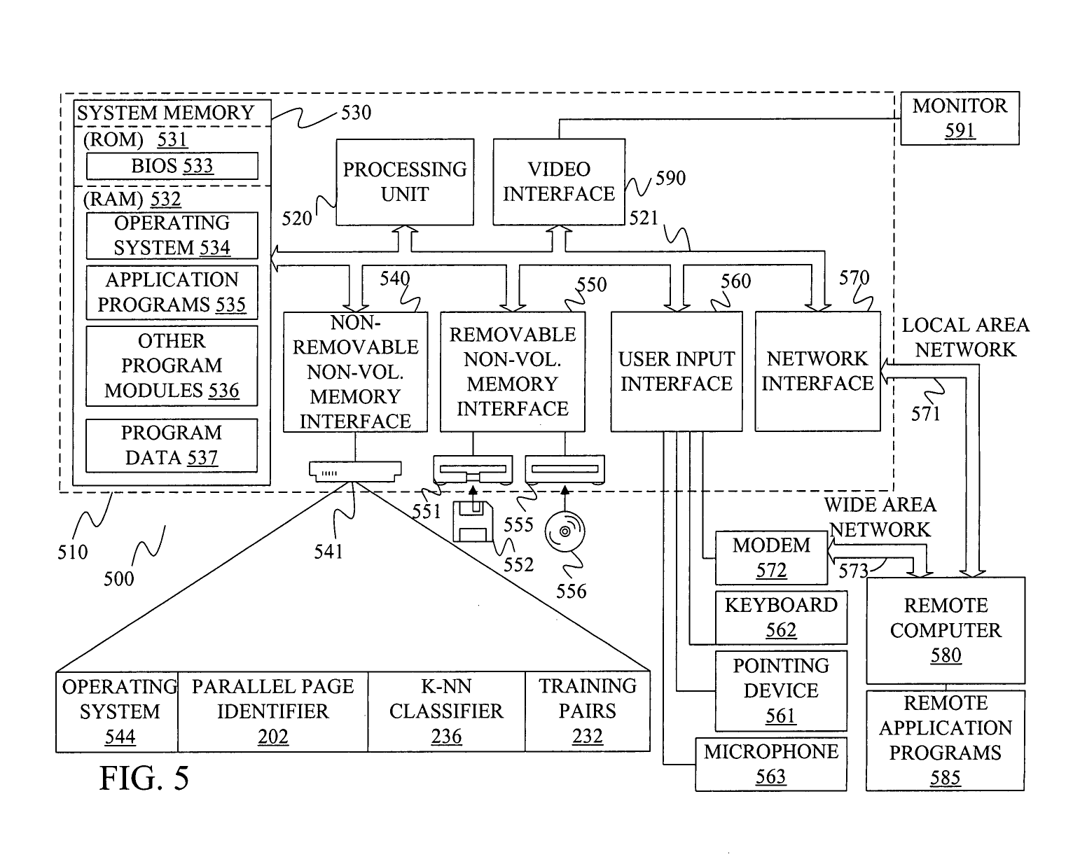

FIG. 5 illustrates an example of a suitable computing system environment 500 on which embodiments may be implemented. The computing system environment 500 is only one example of a suitable computing environment and is not intended to suggest any limitation as to the scope of use or functionality of the claimed subject matter. Neither should the computing environment 500 be interpreted as having any dependency or requirement relating to any one or combination of components illustrated in the exemplary operating environment 500.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 5, an exemplary system for implementing some embodiments includes a general-purpose computing device in the form of a computer 510. Components of computer 510 may include, but are not limited to, a processing unit 520, a system memory 530, and a system bus 521 that couples various system components including the system memory to the processing unit 520.

Computer 510 typically includes a variety of computer readable media. Computer readable media can be any available media that can be accessed by computer 510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 510. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536, and program data 537.

The computer 510 may also include other removable/non-removable volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media discussed above and illustrated in FIG. 5, provide storage of computer readable instructions, data structures, program modules and other data for the computer 510. In FIG. 5, for example hard disk drive 541 is illustrated as storing operating system 544, parallel page identifier 202, K-nearest neighbor classifier 236 and training candidate pairs 232.

A user may enter commands and information into the computer 510 through input devices such as a keyboard 562, a microphone 563, and a pointing device 561, such as a mouse, trackball or touch pad. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590.

The computer 510 is operated in a networked environment using logical connections to one or more remote computers, such as a remote computer 580. The remote computer 580 may be a personal computer, a hand-held device, a server, a router, a network PC, a peer device or other common network node, and typically includes many or all of the elements described above relative to the computer 510. The logical connections depicted in FIG. 5 include a local area network (LAN) 571 and a wide area network (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560, or other appropriate mechanism. In a networked environment, program modules depicted relative to the computer 510, or portions thereof, may be stored in the remote memory storage device. By way of example, and not limitation, FIG. 5 illustrates remote application programs 585 as residing on remote computer 580. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
identifying network pages based on whether the pages include image alternative text that indicates that the network pages contain links to pages that are translations of each other;
retrieving a plurality of pages and a plurality of respective uniform resource locators from a server associated with the domain name of the identified network pages;
using the uniform resource locators to identify a set of candidate parallel page pairs;
creating a set of features for each candidate parallel page pair; and
using the sets of features to identify parallel page pairs, wherein the pages in a parallel page pair are translations of each other.

2. The method of claim 1 wherein identifying network pages further comprises identifying additional network pages based on whether the network pages include anchor text that indicates that the network pages contain links to pages that are translations of each other.

3. The method of claim 1 wherein using the uniform resource locators to identify a set of candidate parallel page pairs comprises:
locating a first uniform resource locator that includes a base pattern;
substituting an alternative pattern for the base pattern in the first uniform resource locator to form a modified resource locator;
locating a second uniform resource locator that is within an edit distance threshold of the modified resource locator; and
setting the pages associated with the first uniform resource locator and the second uniform resource locator as a candidate parallel page pair.

4. The method of claim 3 wherein the edit distance threshold is greater than a predefined value.

5. The method of claim 3 wherein locating a second uniform resource locator comprises:
locating a plurality of uniform resource locators that are within the edit distance threshold of the modified resource locator; and
selecting the uniform resource locator that has the smallest edit distance to the modified resource locator as the second uniform resource locator.

6. The method of claim 1 wherein using the sets of features to identify parallel page pairs comprises, for each set of features, applying the set of features to a k-nearest neighbor classifier to classify the candidate parallel page pair as being either a parallel page pair or not a parallel page pair.

7. The method of claim 6 wherein the k-nearest neighbor classifier utilizes a vector that is based on at least two features.

8. A computer-readable medium having computer-executable instructions for performing steps comprising:
receiving a set of uniform resource locators;
locating a first uniform resource locator that contains a base pattern in the set of uniform resource locators;
modifying the first uniform resource locator by replacing the base pattern with an alternative pattern to form a modified uniform resource locator;
locating at least one uniform resource locator in the set of uniform resource locators that is different from the modified uniform resource locator but is within an edit distance threshold of the modified uniform resource locator to identify a second uniform resource locator; and
indicating that a page associated with the first uniform resource locator and a page associated with the second uniform resource locator are candidate parallel pages that are likely to represent the same content in two different languages.

9. The computer-readable medium of claim 8 wherein identifying a second uniform resource locator comprises:
locating a plurality of uniform resource locators that are different from the modified uniform resource locator but are within the edit distance threshold of the modified uniform resource locator; and
selecting the uniform resource locator that is the shortest edit distance from the modified uniform resource locator as the second uniform resource locator.

10. The computer-readable medium of claim 8 wherein the steps of modifying the first uniform resource locator by replacing the base pattern with an alternative pattern to form a modified uniform resource locator, locating at least one uniform resource locator in the set of uniform resource locators that is different from the modified uniform resource locator but is within the edit distance threshold of the modified uniform resource locator to identify a second uniform resource locator, and indicating a page associated with the first uniform resource locator and a page associated with the second uniform resource locator as candidate parallel pages that represent the same content in two different languages are repeated for each of a plurality of alternative patterns.

11. The computer-readable medium of claim 8 wherein the steps of locating a first uniform resource locator that contains a base pattern, modifying the first uniform resource locator by replacing the base pattern with an alternative pattern to form a modified uniform resource locator, locating at least one uniform resource locator in the set of uniform resource locators that is different from the modified uniform resource locator but is within the edit distance threshold of the modified uniform resource locator to identify a second uniform resource locator, and indicating a page associated with the first uniform resource locator and a page associated with the second uniform resource locator as candidate parallel pages that represent the same content in two different languages are repeated for each of a set of base patterns.

12. The computer-readable medium of claim 8 wherein receiving a set of uniform resource locators comprises receiving a set of uniform resource locators based on a search query that references an image alternative attribute.

13. The computer-readable medium of claim 10 wherein receiving a set of uniform resource locators further comprises receiving a set of uniform resource locators based on a search query that references tags associated with links to other pages.

14. The computer-readable medium of claim 8 for performing further steps comprising:
determining a feature vector for the candidate parallel pages; and
applying the feature vector to a k-nearest neighbor classifier to classify the candidate parallel pages as either containing the same content in different languages or not containing the same content.

15. A method comprising:
determining a feature vector for a pair of documents comprising a document in a first language and a document in a second language;
applying the feature vector to a k-nearest neighbor classifier to classify the pair of documents as either containing the same content in different languages or not containing the same content.

16. The method of claim 15 wherein the feature vector comprises:
a vector element based on a length ratio between the document in the first language and the document in the second language;
a vector element based on a structural difference measure that is related to tags in the document in the first language and tags in the document in the second language; and
a vector element based on a translation alignment ratio for text other than the tags in the document in the first language and text other than tags in the document in the second language.

17. The method of claim 15 wherein the pair of documents are identified from the Internet.

18. The method of claim 17 wherein the pair of documents are identified through steps comprising:
locating an initial page by searching for a page that contains certain image alternative text;
downloading all pages associated with the domain name of the initial page; and
selecting the document in the first language and a document in the second language from the downloaded pages to form the pair based on the uniform resource locators of the documents.

19. The method of claim 18 wherein selecting the documents based on the uniform resource locators of the documents comprises:
searching the uniform resource locators of the downloaded pages for a uniform resource locator with a character sequence that indicates that the page is a version of a page for a particular language;
replacing the character sequence in the uniform resource locator with a second character sequence to form a modified uniform resource locator;
searching the uniform resource locators of the downloaded pages for uniform resource locators that are similar to the modified resource locator; and
selecting the document with the uniform resource locator that includes the character sequence and a document with the uniform resource locator that is similar to the modified uniform resource locator as the documents in the pair of documents.

20. The method of claim 19 wherein searching the uniform resource locators of the downloaded pages for uniform resource locators that are similar to the modified uniform resource locator comprises searching for uniform resource locators that are different form the modified uniform resource locator but that are within an edit distance threshold of the modified uniform resource locator.
